(19) United States
(12) Patent Application Publication
(10) Pub. No.: US 2020/0394619 A1
(43) Pub. Date: Dec. 17, 2020

(54) DYNAMIC VARYIANCE OF CRYPTO TOKENS SUPPLY INCLUDING USER HOLDINGS

(71) Applicant: Yassir Fathi A. Afaneh, Dubai (AE)

(72) Inventor: Yassir Fathi A. Afaneh, Dubai (AE)

(21) Appl. No.: 16/523,526

(22) Filed: Jul. 26, 2019

Related U.S. Application Data
(63) Continuation of application No. 16/443,355, filed on Jun. 17, 2019, now abandoned.

(51) Int. Cl. G06Q 20/06; G06Q 20/38; H04L 9/08

(52) U.S. Cl. CPC G06Q 20/0658; G06Q 20/389; G06Q 20/3829; G06Q 2220/00; H04L 9/0861; H04L 2209/38; H04L 2209/56; H04L 9/0894

(57) ABSTRACT

The present invention discloses q system and method to vary the crypto tokens supply proportionally including user holdings. A multiplier method is used to change the number of tokens proportionally in a blockchain including the existing tokens with users. Moreover, the software application adjusts the existing number of crypto currency tokens or any issued tokens proportionally using the multiplier method. The method comprises of providing a total supply of a digital currency, adjusting and controlling supply of the digital currency using a multiplier technique proportionally, then updating the supply of digital currency and generating a transaction and the transaction comprises a share of the digital currency of at least one user stored in a block. The transaction is later sent to a blockchain by means of a communication interface.

### TECHNICAL FIELD

The invention generally relates to crypto currency techniques in computer networks. More specifically, the invention is related to dynamically increasing and decreasing the crypto tokens supply including user holdings based on multipliers.

### BACKGROUND OF THE INVENTION

Blockchain and crypto tokens are becoming common in use as a payment service for exchange of goods and services either as independent currency or pegged to fiat currency or value (as in the case of stable coins).

Crypto currency is a digital currency built with cryptographic protocols that make transactions secure and difficult to intercept. The most important feature of a crypto currency is that it is not controlled by any central authority or a centralized network. The decentralized nature of blockchain makes crypto currency theoretically immune to any authority control and interference.

Decentralized crypto currency systems such as Bitcoin and Ethereum have been developed and seen widespread acceptance for a few years. Most of the crypto currency systems or crypto currencies consist of transactional and monetary properties.

Crypto currencies have several transactional properties in common. The transactional properties include lack of permission required, irreversible, highly secure, instantaneous, and anonymous. Anyone can download the necessary software or program application to mine, trade, and purchase things with crypto currencies. Moreover, any of the trading methods using crypto currencies are irreversible. Once a transfer is made using crypto currency, no one has the authority to reverse the transaction. The transactions using crypto currencies are governed by a security system known as cryptography. The cryptography security system enables a sender to send the crypto currency, such as a Bitcoin to a receiver and the crypto currency can only be received and be deposited into a particular receiver account if the receiver has the corresponding key or cipher. This means that anybody without the proper decryption cipher cannot view, send, or receive funds. Another highly valuable property of the modern crypto currency is that the transfers happen immediately. It is to be noted that currencies such as Bitcoin and Ethereum are sent from processor and to addresses, not the names of people. Therefore, crypto currencies are totally anonymous and people will never know who is spending or sending the crypto currency.

Crypto currencies also have a couple of specific monetary properties that set them apart from other forms of currency. More specifically, the crypto currencies are not created or monitored by any kind of centralized governing body and therefore have different treatments as digital currencies by regularity authorities.

It is to be noted that crypto tokens are tokenized data relating to transactions that can be sent across the internet and stored as a blockchain without jeopardizing sensitive data.

Basically, each token is unique and corresponds to important data used to create a transaction but doesn't contain that data specifically so it can be shared publicly without jeopardizing the sensitive information. It is a unique code in the form of a hash function that relates back to a specific transaction without containing sensitive information about it. This allows people to confirm ownership of Bitcoin on the public ledger by means of a blockchain without sharing sensitive information. As a result, the blockchain is full of tokens of this type sitting next to public transaction data. A token identifies the transaction and is created by the sender automatically, and the rest of the transaction data is recorded along with it.

While the tokens are digital, commonly crypto currencies limit the supply to prevent inflation. For example, Bitcoin is limited to 21 million tokens. However, there could be a need to either increase or decrease the supply of total tokens or vary user holdings. Unfortunately, no one solution has addressed these issues.

In one of the closest prior art references, US'10565 discloses a communication system that includes a token generator to create one or more tokens, as well as a token action log to associate each token with a customizable set of one or more actions, where each token is to trigger the associated set of one or more actions in response to accompanying a communication that experiences an event. The communication system also includes a token distributor to make the one or more tokens available for distribution to entities potentially desiring to communicate with the communication system. However, regulation of supply of digital tokens is not disclosed.

Similarly, in one of the art US'636 discloses a game system, and arcade game apparatus and management apparatus. In the game system, each game apparatus change at the same timing to a second mode in which a jackpot drawing is carried out in a state that a jackpot prize winning probability is high. When the jackpot prize is awarded during the second mode, a winning notice is sent to a management apparatus via communication network. The management apparatus transmits second mode end information to all the game apparatus when the number of game apparatus sending the winning notice reaches a predetermined number. After that, the game apparatus operating in the second mode changes to a first mode in which the jackpot drawing is carried out in a state that the winning probability of the jackpot prize is low. However, there is no solution described regarding controlling the supply in a blockchain.

In other prior art, WO'3341A1 discloses a system for performing transaction mixing between a plurality of users on a blockchain. The blockchain may be, for example, the Bitcoin blockchain. The system is configured to carry out the steps of: (i) preparing a first commitment transaction arranged to transmit control of a resource from a source address of a first user to a receiving address of a second user; (ii) preparing a second commitment transaction arranged to transmit control of a resource from a source address of the second user to a receiving address of a further user; (iii) preparing a further commitment transaction arranged to transmit control of a resource from a source address of the further user to either: (a) a receiving address of the first user; or (b) a receiving address of a yet further user and repeating step (iii) until option (a) is performed to complete a transaction chain; and (iv) executing the transaction chain. At least one of the users is randomly chosen from the plurality. Eventually, the proportional distribution of Bitcoin is not discussed.

In view of above mentioned shortcomings in the prior art, there is an urgent and unmet need to control the supply of tokens proportionally in a blockchain

### SUMMARY OF THE INVENTION

The instant invention discloses a split coin that may solve the above mentioned problem and provides a mechanism to increase or decrease the nominal supply as needed. Split coin also attempts to increase or decrease the supply proportionally for all participants.

Disclosed herein are a system, method, and computer program product stored on non-transitory storage media for introducing and varying blockchain based crypto-currency tokens proportionally.

In one of the preferred embodiments, a blockchain transaction device is disclosed. The transaction device is arranged to control supply of a digital currency to prevent inflation. The blockchain transaction device comprising: an electronic memory system comprising: a security data area storing a private key pair and a public key pair, and a controller application, the controller application having access to the security data area; a processor configured to execute the generator application, wherein the generator application comprises a split coin module and a transaction module; the split coin module is configured for adjusting and controlling supply of the digital currency using a multiplier technique; the transaction module is configured to generate a transaction and transaction comprises a share of the digital currency of at least one user stored in a block; a communication interface arranged to transmit the transaction for inclusion in a blockchain.

In another embodiment of the invention, a blockchain transaction method arranged to control a supply of a digital currency is disclosed. The blockchain transaction method comprising providing a total supply of a digital currency; adjusting and controlling supply of the digital currency using a multiplier technique proportionally; updating the supply of digital currency; generating a transaction and transaction comprises a share of the digital currency of at least one user stored in a block; transmitting the transaction to a communication interface in a blockchain.

In another embodiment of the invention, a software application in the form of blockchain apps is provided to give rewards proportionally in a loyalty program. A multiplier method is used to change the number of tokens proportionally in a blockchain including the existing tokens with users. Moreover, the software application adjusts the existing number of crypto currency tokens or any issued tokens proportionally using the multiplier method. This also includes the existing tokens that already carried with holders.

In another embodiment of the invention, a method is disclosed for giving dividend tokens or bonus tokens proportionally to current crypto currency holders.

In another embodiment of the invention, a method is disclosed for giving dividend tokens or bonus tokens proportionally to current holders. This method controls the supply of cryptocurrencies by increasing or decreasing the number of tokens even the ones available with holders according to different economic indicators such as inflation or deflation.

### BRIEF DESCRIPTION OF DRAWINGS

The embodiments herein will be better understood from the following detailed description with reference to the drawings, in which:

FIG. 1 illustrates a blockchain transaction device arranged to control supply of a digital currency.

FIG. 2 illustrates a blockchain transaction method arranged to control a supply of a digital currency.

FIG. 3 illustrates a method for increasing the number of tokens; and

FIG. 4 illustrates a method of decreasing the number of tokens.

### DETAILED DESCRIPTION OF THE INVENTION

The embodiments herein and the various features and advantageous details thereof are explained more fully with reference to the non-limiting embodiments that are illustrated in the following detailed description. Descriptions of well-known components and processing techniques are omitted so as to not unnecessarily obscure the embodiments herein. The examples used herein are intended merely to facilitate an understanding of ways in which the embodiments herein may be practiced and to further enable those of skilled in the art to practice the embodiments herein. Accordingly, the examples should not be construed as limiting the scope of the embodiments herein.

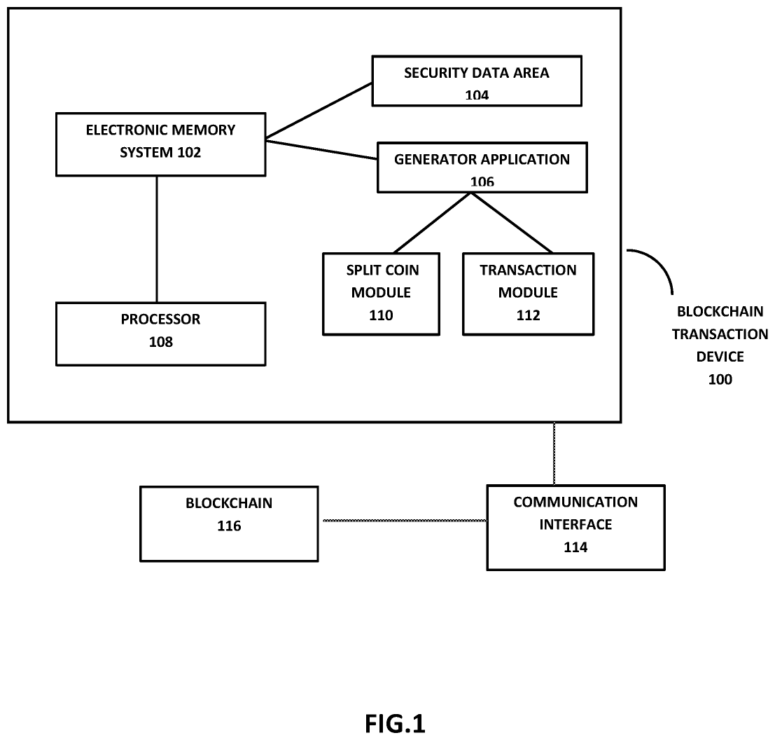

FIG. 1 illustrates a blockchain transaction device (100) arranged to control supply of a digital currency. The blockchain transaction device comprising: an electronic memory system (102) comprising: a security data area (104) storing a private key pair and a public key pair, and a generator application (106), the generator application having access to the security data area (104); a processor (108) configured to execute the generator application (106), wherein the generator application comprises a split coin module (110) and a transaction module (112); the split coin module (110) is configured for adjusting and controlling supply of the digital currency using a multiplier technique; the transaction module (112) is configured to generate a transaction and transaction comprises a share of the digital currency of at least one user stored in a block; a communication interface (114) arranged to transmit the transaction for inclusion in a blockchain (116).

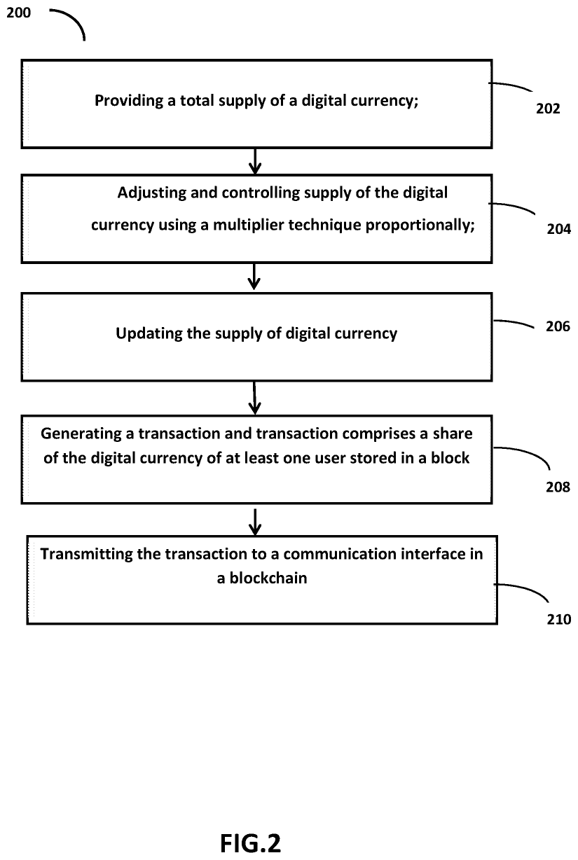

FIG. 2 illustrates a blockchain transaction method arranged to control a supply of a digital currency (200). A blockchain transaction method arranged to control a supply of a digital currency is disclosed. The blockchain transaction method comprising providing a total supply of a digital currency (202); adjusting and controlling supply of the digital currency using a multiplier technique proportionally (204); updating the supply of digital currency (206); generating a transaction and transaction comprises a share of the digital currency of at least one user stored in a block (208); transmitting the transaction to a communication interface in a blockchain (210).

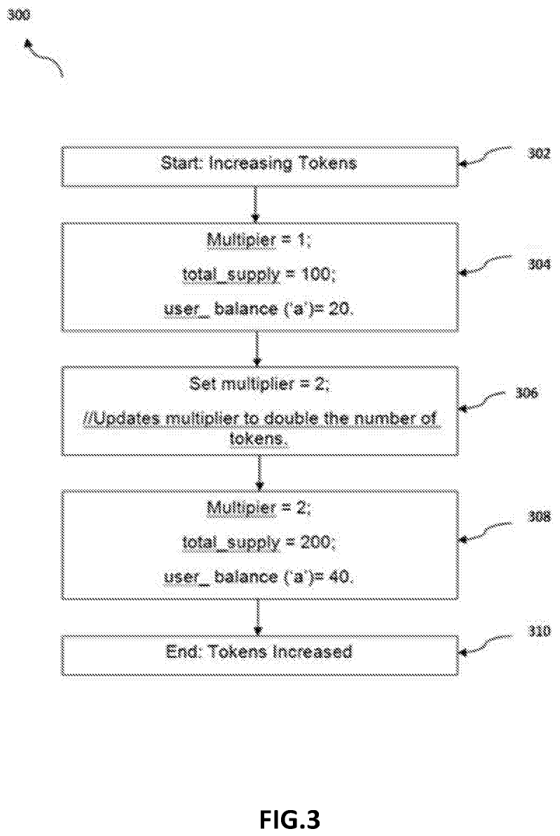

FIG. 3 illustrates a method of increasing the tokens (300), start increase of tokens (302), assuming the total supply of tokens 100 and multiplier is 1, a user ‘A’ holds 20 tokens in his/her split coin wallet. Therefore, call to blockchain's API for total supply will return 100 and call for balance in user A's wallet will return 20 (304). Any update to the multiplier raises multiplier update event and thus multiplies the number of tokens. Let's assume multiplier is changed to 2 to double the supply (306), then call to blockchain's total supply api will return 200 and call for user A's balance will return 40 (308).

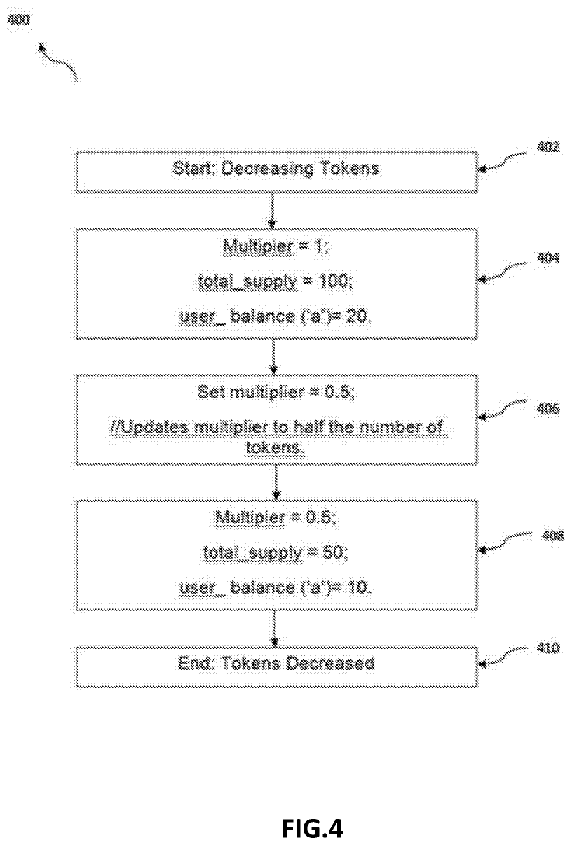

FIG. 4 illustrates a method of decreasing the tokens (400), start decreasing the tokens (402), assuming the total supply of tokens 100 and multiplier is 1, a user ‘A’ holds 20 tokens in his/her split coin wallet. Therefore, call to blockchain's API for total supply will return 100 and call for balance in user A's wallet will return 20 (404). Any update to the multiplier raises multiplier update event and thus multiplies the number of tokens. Let's assume multiplier is changed to 0.5 to reduce the supply by half (406), then call to blockchain's API will return 50 for total supply and call to blockchain's api will return 10 for user A's wallet balance (408).

The present invention claims a blockchain transaction device is disclosed. The transaction device is arranged to control supply of a digital currency to prevent inflation. The blockchain transaction device comprising: an electronic memory system comprising: a security data area storing a private key pair and a public key pair, and a controller application, the controller application having access to the security data area; a processor configured to execute the generator application, wherein the generator application comprises a split coin module and a transaction module; the split coin module is configured for adjusting and controlling supply of the digital currency using a multiplier technique; the transaction module is configured to generate a transaction and transaction comprises a share of the digital currency of at least one user stored in a block; a communication interface arranged to transmit the transaction for inclusion in a blockchain.

The present invention claims a blockchain transaction method arranged to control a supply of a digital currency is disclosed. The blockchain transaction method comprising providing a total supply of a digital currency; adjusting and controlling supply of the digital currency using a multiplier technique proportionally; updating the supply of digital currency; generating a transaction and transaction comprises a share of the digital currency of at least one user stored in a block; transmitting the transaction to a communication interface in a blockchain.

The present invention aims at increasing and decreasing the number of token proportionally including the holding of users. The present invention is objected to control the supply using a multiplier technique. The invention may be implemented on ERC20 token. However, it can be implemented in any other language.

Blockchain and crypto tokens are becoming common for exchange of goods and services either as independent currency or pegged to fiat currency or value (as in the case of stable coins).

Commonly crypto currencies limits the supply to prevent inflation (for example Bitcoin is limited to 21 million tokens) but there could be need to do both increase or decrease the supply; therefore, split coin tries to solve this problem and gives a mechanism to increase or decrease the nominal supply as needed. Split coin also attempts to increase or decrease the supply proportionally for all participants.

Each of the steps described herein can be performed using a general purpose computing device, e.g., a personal computer, personal digital assistant, and/or computing device that is in communication with a network, e.g., internet, intranet, or extranet, that includes a memory and a set of instructions, that is, logic, specifically scripted to perform the functions, steps, communications, and data manipulations described herein. As the present invention is not limited to any specific instruction set, e.g., code, usable to implement one or more aspects of the present invention, and as those of skilled in the art are well aware of the ways to instruct such a computing device to implement such functions, steps, communications, and data manipulations, further details of such specific instruction sets will not be provided here so as to not obscure the present invention. While one or more of the functions, steps, communications, and data manipulations can be performed by hand or by a computer-implemented instruction set, the present invention is not limited to any one sub combination thereof. Data gathering can be performed manually, in a semi-automated manner (e.g., given to a human person who then inputs the data into a computing device's memory), or in a fully-automated manner (e.g., the customer interacts directly with a computing device to input the data into a computer's memory). As will be readily appreciated by those of skilled in the art, the present invention also includes the use of multiple computing devices on a communications network (including the use of removable memory media to transfer data between devices), including that the computing device via which data is input by any one human user is different from a computing device that implements decision instruction sets

As mentioned, there remains the foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed

What is claimed is:

1. A blockchain transaction device arranged to control supply of a digital currency, the blockchain transaction device comprising:
an electronic memory system comprising:
a security data area storing a private key pair and a public key pair, and a generator application, the generator application having access to the security data area;
a processor configured to execute the generator application, wherein the generator application comprises a split coin module and a transaction module;
the split coin module is configured for adjusting and controlling supply of the digital currency using a proportional multiplier technique;
the transaction module is configured to generate a transaction and transaction comprises a share of digital currency of at least one user stored in a block and;
a communication interface arranged to transmit the transaction for inclusion in a blockchain;
wherein the generator application adjusts and controls the supply of the digital currency based on gathered data related to inflation; and
the proportional multiplier technique multiples the total number of digital currency and number of digital currency in account of all the user by same multiplier.

2. The blockchain transaction device as claimed in claim 1, wherein the blockchain device is selected from a mobile phone, a configurable device with a processor, a laptop, a computer system.

3. The blockchain transaction device as claimed in claim 1, wherein the generator application comprises a key generation interface to generate the public key pair and the private key pair.

4. The blockchain transaction device as claimed in claim 1, wherein the security data area comprises a high security data area and a low security data area.

5. The blockchain transaction device as claimed in claim 4, wherein the high security data area is arranged to store multiple data determining private keys, the multiple private keys being indexed with a corresponding key index, wherein the low security data part comprises a mapping between a key identifier of a private key and the key index.

6. The blockchain transaction device as claimed in claim 1, wherein the blockchain transaction device is connected to an online server.

7. (canceled)

8. The blockchain transaction device as claimed in claim 1, wherein the blockchain device is configured to prevent inflation of the digital currency.

9. The blockchain transaction device as claimed in claim 1, wherein the digital currency is Bitcoin.

10. A blockchain transaction method arranged to control a supply of a digital currency, the blockchain transaction method comprising:
providing a total supply of digital currency;
gathering data related to the inflation;
adjusting and controlling supply of the digital currency using a proportional multiplier technique, depending on the gathered data;
updating the supply of the digital currency;
generating a transaction and transaction comprises a share of the digital currency of at least one user stored in a block;
transmitting the transaction to a communication interface in blockchain; and
wherein the proportional multiplier technique multiples the total number of digital currency and number of digital currency in account of all the user by same multiplier.

11. (canceled)

12. The blockchain transaction device as claimed in claim 10, wherein the blockchain device transaction method is configured to prevent inflation of the digital currency.

13. The blockchain transaction method as claimed in claim 10, wherein the digital currency is Bitcoin
